(19) United States
(12) Patent Application Publication
(10) Pub. No.: US 2016/0180799 A1
(43) Pub. Date: Jun. 23, 2016

(54) MULTI-USER NOTIFICATION SYSTEM

(71) Applicant: Intel Corporation, Santa Clara, CA (US)

(72) Inventor: Raghvendra Maloo, Bangalore (IN)

(21) Appl. No.: 14/581,386

(22) Filed: Dec. 23, 2014

(51) Int. Cl. G09G 5/00; G06K 9/00; G06F 21/32; G06F 3/01

(52) U.S. Cl. CPC G09G 5/003; G06F 3/017; G06K 9/00288; G06F 21/32

(57) ABSTRACT

Various systems and methods for a multi-user notification system are described herein. A system for displaying notifications includes a detection module to detect at a computing device, a presence of a user, an identification module to identify the user, a notification module to determine a notification for the user when the user is identified, a display module to display the notification to the user on a display of the computing device.

### TECHNICAL FIELD

Embodiments described herein generally relate to electronic notifications and in particular, to a multi-user notification system.

### BACKGROUND

Computing devices are become more prevalent in family and intimate multi-user environments Families may share a desktop computer, laptop, or tablet device. Each person in the family may access the computing device several times a day.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a computing environment, according to an embodiment;

FIG. 2 is a data flow diagram illustrating a process, according to an embodiment;

FIG. 3 is a block diagram illustrating a system for displaying notifications, according to an embodiment;

FIG. 4 is a flowchart illustrating a method of displaying notifications, according to an embodiment; and

FIG. 5 is a block diagram illustrating an example machine upon which any one or more of the techniques (e.g., methodologies) discussed herein may perform, according to an example embodiment.

### DETAILED DESCRIPTION

Systems and methods described herein provide mechanisms for a multi-user notification system. All-in-one systems, laptops, desktops, tablets, and other computing devices are often shared by members of a group, such as a family. Such computing devices typically have an authentication or login mechanism to unlock the system and allow the user to access the programs and data stored thereon. In the case where there are multiple users of single machine, one user may remain logged in, which may prohibit other users from accessing their accounts or data. To enrich the users' experience with the computing system, the system may detect a user's presence automatically and display notifications particular to the user. Such a system may satisfy a user expectation to be able to check on various notifications or statuses, such as new emails, reminders, alarms, etc., quickly and easily.

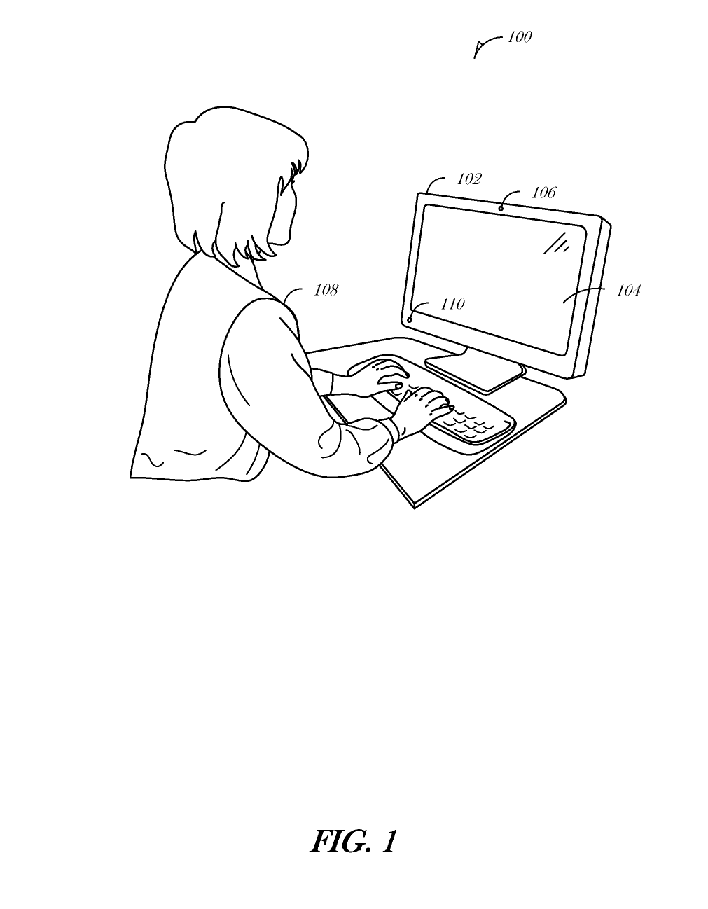

FIG. 1 is a schematic drawing illustrating a computing environment 100, according to an embodiment. The computing environment 100 includes a computing device 102, which includes a display 104 and a camera 106. While the computing device 102 illustrated in FIG. 1 is an all-in-one personal computer (PC), it is understood that the computing device 102 may take one of many forms, such as a laptop, desktop, tablet, hybrid, mobile phone, or the like. The computing device 102 supports multiple users, each user having their own account. The computing device 102 also supports locking an account. For example, when a user is finished with using the computer, the user may be presented the option to log off, lock, or power off the computing device 102. In various examples, the computing device 102 may automatically lock after a timeout period.

While locked, the computing device 102 is generally unavailable for other users. In the example illustrated in FIG. 1, the computing device 102 is in a locked state. As a different user 108 approaches the computing device 102, sensors in or around the computing device 102 detect the presence of the user 108. For example, a proximity sensor 110 may be built into the computing device 102. The proximity sensor 110 may be any type of sensor able to detect proximate motion, such as an infrared (IR) motion detector, an acoustic detector, an ultrasonic detector, a video camera, or the like. While the proximity sensor 110 is illustrated as being incorporated into the computing device 102 in FIG. 1, it is understood that the proximity sensor 110 may be located in various places, such as in a ceiling mount, a floor device, or other places, and in communication with the computing device 102 to notify the computing device 102 of a person proximate to the computing device 102.

After the user 108 is detected as being near the computing device 102, the camera 106 is used to capture one or more images of the user's 108 face. The images are analyzed with facial recognition techniques to determine the user's 108 identity. If the user 108 is recognized and authenticated, one or more notifications may be presented on the display 106. The notifications may be provided even when the computing device 102 is locked by another user. The notifications are specific to the user 108 at the computing device 102, not the active user (the one logged in). It is understood that some notifications that would be presented to both the active user and the user at the computing device 102 (e.g., user 108) may be presented. Such general notifications may be system alerts (e.g., low battery warning), or other notifications, alerts, reminders, or the like that are targeted for general viewing or consumption.

In some embodiments, the user 108 is able to interact with the notifications once they are displayed. The interaction may be limited due to the fact that the user 108 is not logged into the computing device 102. For example, the user 108 may be able to dismiss a reminder, mark an email as “read”, accept an invitation, or “like” a post on a social network platform, but may be unable to respond to an email or text. Such interaction may be implemented using air gestures, touch gestures, voice commands, or other conventional input mechanisms (e.g., mouse or keyboard).

By using proximity detection and facial recognition, the computing system 102 is able to provide a seamless interaction to the user 108 and increase the efficiency and enjoyment of the user of the computing system 102.

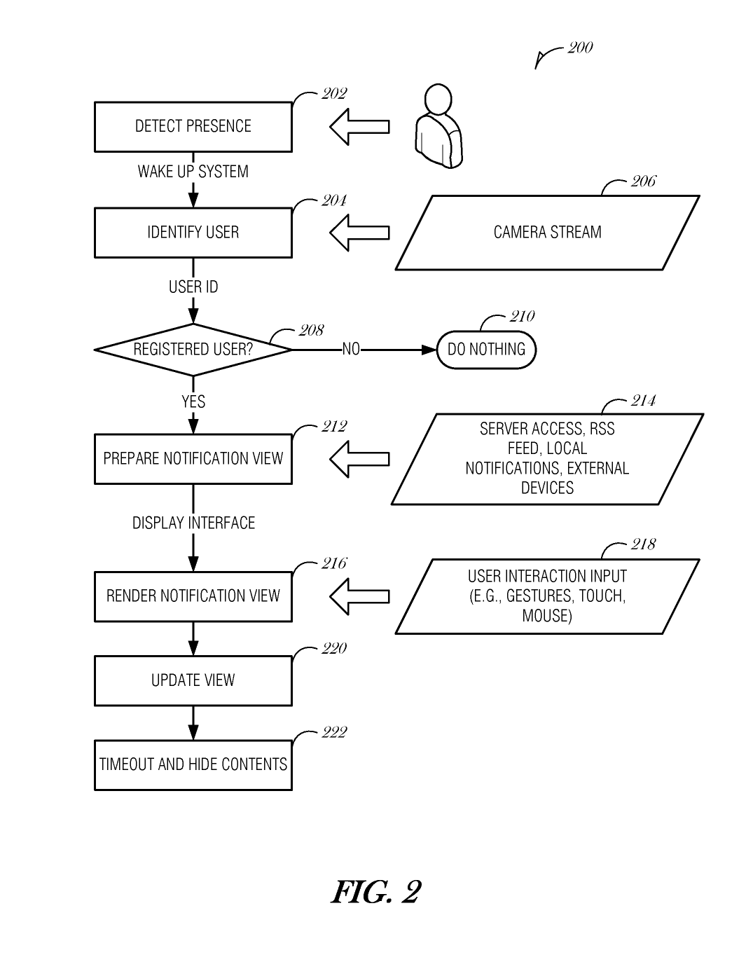

FIG. 2 is a data flow diagram illustrating a process 200, according to an embodiment. At block 202, a user's presence is detected. The user's presence may be detected by various types of proximity detectors. The user is identified (block 204) based on input data from a camera stream (data item 206). The camera stream may be continually gathered (e.g., the camera is persistently operating) or may be triggered upon the user's presence being detected. The camera may be used to detect the user's presence in block 202, so the camera stream may be readily available.

A user identification (USER ID) is obtained at block 204 and passed to the decision block 208, where a determination is made of whether the user is recognized. If the user is not recognized, then no action is taken and the process 200 ends (block 210). Alternatively, if the user is recognized, then a notification view is prepared (block 212). The notification view may be prepared based on various data collected from servers, platforms, services, an RSS feed, local alerts or notifications, external devices, etc. External devices may include home automation devices, other appliances (e.g., television), or the like. The notification data (data item 214) is collected and used to prepare the notification view (block 212).

A display interface is used to pass the data for the notification view to block 216, which is where the notification view is rendered. The user may then view the pending notifications and interact with them using various input mechanisms, such as air gestures, touch input, or the like. If the user changes the state of one or more notifications, then the view is updated (block 220). After a time, the notification view may be hidden. For example, after a user-defined timeout (e.g., 15 minutes), the notification view for a particular user is removed from a display screen. The timeout may be based on a time of inactivity as determined by various sensors (e.g., camera or proximity detector) or inputs (e.g., mouse).

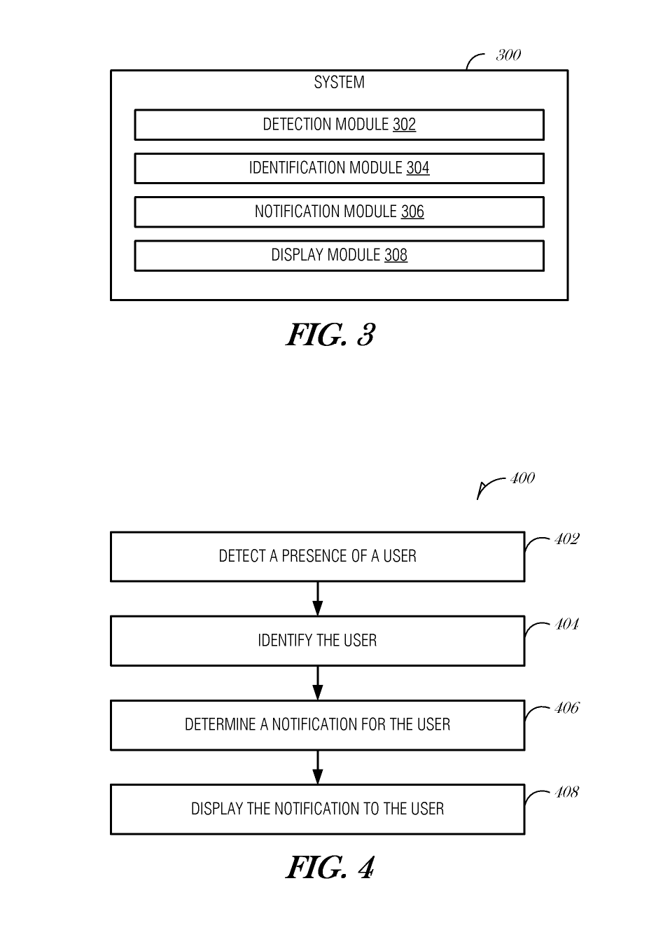

FIG. 3 is a block diagram illustrating a system 300 for displaying notifications, according to an embodiment. The system 300 includes a detection module 302, an identification module 304, a notification module 306, and a display module 308. The detection module 302 may be configured to detect at a computing device, a presence of a user.

In an embodiment, to detect the user presence, the detection module 302 is to detect the user presence with a motion detector. In various embodiments, the motion detector is one of: an infrared detector, a camera, an ultrasonic detector, or an acoustic detector.

The identification module 304 may be configured to identify the user. In an embodiment, to identify the user, the identification module 304 is to obtain an image of the user from a camera proximate to the computing device and analyze the image to identify the user. The camera may be incorporated into the computing device or co-located with the computing device.

In an embodiment, the identification module 304 is to authenticate the image of the user. For example, the identification module 304 may use various anti-spoof or liveness tests to ensure that the user is actually present. Liveness or anti-spoof tests may test whether the image is of a picture, video, other inanimate object attempting to represent the user.

The notification module 306 may be configured to determine a notification for the user when the user is identified. In an embodiment, to determine the notification for the user, the notification module 304 is to access an account of the user to obtain data and identify the notification from the data. For example, the account may be of a social network account (e.g., Facebook®). The data may represent a feed or stream of data from the account. The feed may be filtered to identify events or posts that should result in a notification being displayed.

In an embodiment, to determine the notification for the user, the notification module 304 is to identify a general notification and use the general notification for the notification for the user. In various embodiments, the general notification is one of: a system status message or an environmental message. For example, a low battery message, a system malfunction, or other system status of the computing device or other devices may be provided to any user of the computing device. Similarly, an environmental message (e.g., a storm warning) may be provided to all users including the user.

In an embodiment, the notification module 306 receives user input from the user, the user input to interact with the notification being displayed. In various embodiments, the user input is one of: an air gesture, a touch gesture, a mouse input, a keyboard input, or a voice command. For example, to dismiss a notification, the user may wave their hand in a sweeping motion from left to right, which may trigger a dismissal operation on the currently-selected notification.

The display module 308 may be configured to display on a display of the computing device, the notification to the user. In an embodiment, to display the notification to the user, the display module 308 is to render a notification view, the notification view including the notification to the user and display the notification view in place of an existing presentation on the display. The notification view may be styled or designed in a particular manner, such as to include scrollable frames with a list of notifications on one portion of the display and a content window displaying the details of the currently selected notification on another portion of the display. The notification view may be customizable by the user. The notification view may also include headers or other indicia to indicate general notifications or user-specific notifications, sources of notifications, date/time stamps of notifications, urgency level, etc.

In an embodiment, the existing presentation includes a lock screen of a different user than the user. Other screens may be the existing presentation, such as a screen saver or a blank screen.

In an embodiment, the detection module 302 is to detect a presence of a second user along with the user. For example, the second user may be standing or sitting next to or behind the user in a manner that both are in the camera frame. In such an embodiment, to identify the user, the identification module 304 is to receive a signal from the user, the signal to cause the computing device to display notifications for the user, and identify the user in response to the signal. The signal may be an air gesture performed by the user, in an embodiment. For example, the computing device may prompt the two users with an alert (e.g., sound, display, or the like) to notify the users that the computing device is unsure which user is to be the active one. The user may then wave his hand, indicating that the computing device should attempt to recognize him and display notifications related to him The signal may alternatively be a voice command or combinations of gestures and voice commands The computing device may display notifications only related to the user identifying himself with the signal. Alternatively, the computing device may display notifications for any of the users in the camera frame that the computing device recognizes and verifies.

FIG. 4 is a flowchart illustrating a method 400 of displaying notifications, according to an embodiment. At block 402, a presence of a user is detected at a computing device. In an embodiment, detecting the user presence comprises detecting the user presence with a motion detector. In various embodiments, the motion detector is one of: an infrared detector, a camera, an ultrasonic detector, or an acoustic detector.

At block 404, the user is identified. In an embodiment, identifying the user comprises obtaining an image of the user from a camera proximate to the computing device and analyzing the image to identify the user. In a further embodiment, the method 400 includes authenticating the image of the user.

At block 406, a notification for the user is determined when the user is identified. In an embodiment, determining the notification for the user comprises accessing an account of the user to obtain data and identifying the notification from the data.

In an embodiment, determining the notification for the user comprises identifying a general notification and using the general notification for the notification for the user. In a further embodiment, the general notification is one of: a system status message or an environmental message.

At block 408, the notification is displayed to the user on a display of the computing device. In an embodiment, displaying the notification to the user comprises rendering a notification view, the notification view including the notification to the user, and displaying the notification view in place of an existing presentation on the display. In a further embodiment, the existing presentation includes a lock screen of a different user than the user.

In an embodiment, the method 400 includes receiving user input from the user, the user input to interact with the notification being displayed. In a further embodiment, the user input is one of: an air gesture, a touch gesture, a mouse input, a keyboard input, or a voice command.

In an embodiment, the method 400 includes detecting a presence of a second user along with the user, receiving a signal from the user, the signal to cause the computing device to display notifications for the user, identifying the user in response to the signal. In a further embodiment, the signal includes an air gesture performed by the user.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

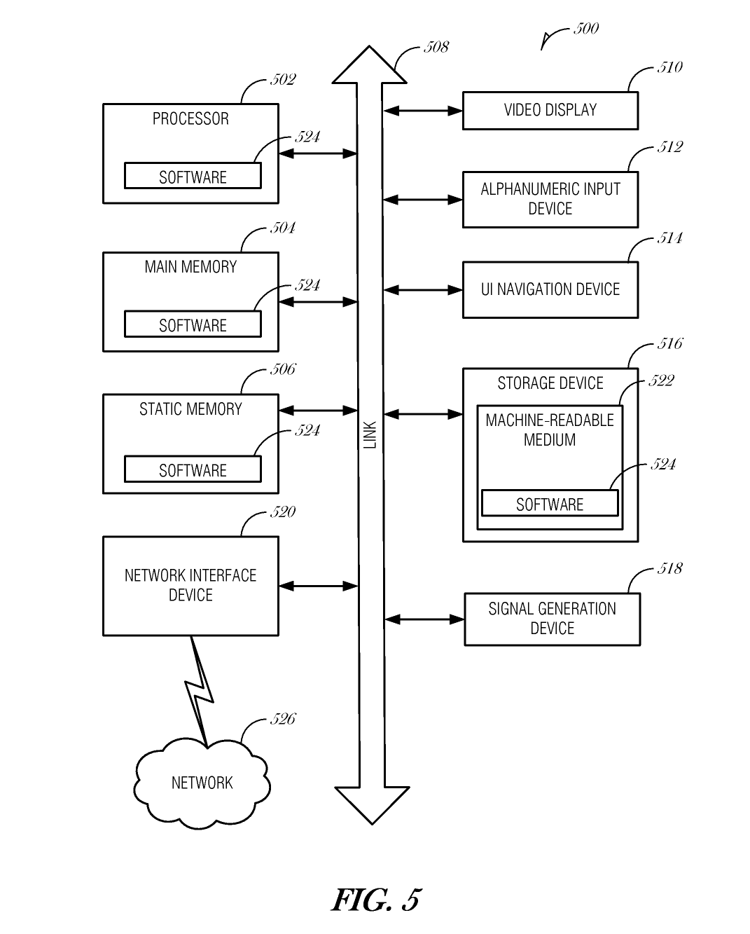

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 includes subject matter for displaying notifications (such as a device, apparatus, or machine) comprising:

Example 1 includes subject matter (such as a device, apparatus, or machine) comprising: a detection module to detect at a computing device, a presence of a user; an identification module to identify the user; a notification module to determine a notification for the user when the user is identified; and a display module to display the notification to the user on a display of the computing device.

In Example 2, the subject matter of Example 1 may include, wherein to detect the user presence, the detection module is to: detect the user presence with a motion detector.

In Example 3, the subject matter of any one of Examples 1 to 2 may include, wherein the motion detector is one of: an infrared detector, a camera, an ultrasonic detector, or an acoustic detector.

In Example 4, the subject matter of any one of Examples 1 to 3 may include, wherein to identify the user, the identification module is to: obtain an image of the user from a camera proximate to the computing device; and analyze the image to identify the user.

In Example 5, the subject matter of any one of Examples 1 to 4 may include, wherein the identification module is to: authenticate the image of the user.

In Example 6, the subject matter of any one of Examples 1 to 5 may include, wherein to determine the notification for the user, the notification module is to: access an account of the user to obtain data; and identify the notification from the data.

In Example 7, the subject matter of any one of Examples 1 to 6 may include, wherein to determine the notification for the user, the notification module is to: identify a general notification; and use the general notification for the notification for the user.

In Example 8, the subject matter of any one of Examples 1 to 7 may include, wherein the general notification is one of: a system status message or an environmental message.

In Example 9, the subject matter of any one of Examples 1 to 8 may include, wherein to display the notification to the user, the display module is to: render a notification view, the notification view including the notification to the user; and display the notification view in place of an existing presentation on the display.

In Example 10, the subject matter of any one of Examples 1 to 9 may include, wherein the existing presentation includes a lock screen of a different user than the user.

In Example 11, the subject matter of any one of Examples 1 to 10 may include, wherein the notification module is to: receive user input from the user, the user input to interact with the notification being displayed.

In Example 12, the subject matter of any one of Examples 1 to 11 may include, wherein the user input is one of: an air gesture, a touch gesture, a mouse input, a keyboard input, or a voice command

In Example 13, the subject matter of any one of Examples 1 to 12 may include, wherein the detection module is to detect a presence of a second user along with the user; and wherein to identify the user, the identification module is to receive a signal from the user, the signal to cause the computing device to display notifications for the user, and identify the user in response to the signal.

In Example 14, the subject matter of any one of Examples 1 to 13 may include, wherein the signal includes an air gesture performed by the user.

Example 15 includes subject matter for displaying notifications (such as a method, means for performing acts, machine readable medium including instructions that when performed by a machine cause the machine to performs acts, or an apparatus to perform) comprising: detecting at a computing device, a presence of a user; identifying the user; determining a notification for the user when the user is identified; and displaying on a display of the computing device, the notification to the user.

In Example 16, the subject matter of Example 15 may include, wherein detecting the user presence comprises: detecting the user presence with a motion detector.

In Example 17, the subject matter of any one of Examples 15 to 16 may include, wherein the motion detector is one of: an infrared detector, a camera, an ultrasonic detector, or an acoustic detector.

In Example 18, the subject matter of any one of Examples 15 to 17 may include, wherein identifying the user comprises: obtaining an image of the user from a camera proximate to the computing device; and analyzing the image to identify the user.

In Example 19, the subject matter of any one of Examples 15 to 18 may include, authenticating the image of the user.

In Example 20, the subject matter of any one of Examples 15 to 19 may include, wherein determining the notification for the user comprises: accessing an account of the user to obtain data; and identifying the notification from the data.

In Example 21, the subject matter of any one of Examples 15 to 20 may include, wherein determining the notification for the user comprises: identifying a general notification; and using the general notification for the notification for the user.

In Example 22, the subject matter of any one of Examples 15 to 21 may include, wherein the general notification is one of: a system status message or an environmental message.

In Example 23, the subject matter of any one of Examples 15 to 22 may include, wherein displaying the notification to the user comprises: rendering a notification view, the notification view including the notification to the user; and displaying the notification view in place of an existing presentation on the display.

In Example 24, the subject matter of any one of Examples 15 to 23 may include, wherein the existing presentation includes a lock screen of a different user than the user.

In Example 25, the subject matter of any one of Examples 15 to 24 may include, receiving user input from the user, the user input to interact with the notification being displayed.

In Example 26, the subject matter of any one of Examples 15 to 25 may include, wherein the user input is one of: an air gesture, a touch gesture, a mouse input, a keyboard input, or a voice command.

In Example 27, the subject matter of any one of Examples 15 to 26 may include, detecting a presence of a second user along with the user; receiving a signal from the user, the signal to cause the computing device to display notifications for the user; and identifying the user in response to the signal.

In Example 28, the subject matter of any one of Examples 15 to 27 may include, wherein the signal includes an air gesture performed by the user.

Example 29 includes at least one machine-readable medium including instructions, which when executed by a machine, cause the machine to perform operations of any of the Examples 15-28.

Example 30 includes an apparatus comprising means for performing any of the Examples 15-28.

Example 31 includes subject matter for displaying notifications (such as a device, apparatus, or machine) comprising: means for detecting at a computing device, a presence of a user; means for identifying the user; means for determining a notification for the user when the user is identified; and means for displaying on a display of the computing device, the notification to the user.

In Example 32, the subject matter of Example 31 may include, wherein the means for detecting the user presence comprises: means for detecting the user presence with a motion detector.

In Example 33, the subject matter of any one of Examples 31 to 32 may include, wherein the motion detector is one of: an infrared detector, a camera, an ultrasonic detector, or an acoustic detector.

In Example 34, the subject matter of any one of Examples 31 to 33 may include, wherein the means for identifying the user comprises: means for obtaining an image of the user from a camera proximate to the computing device; and means for analyzing the image to identify the user.

In Example 35, the subject matter of any one of Examples 31 to 34 may include, means for authenticating the image of the user.

In Example 36, the subject matter of any one of Examples 31 to 35 may include, wherein the means for determining the notification for the user comprises: means for accessing an account of the user to obtain data; and means for identifying the notification from the data.

In Example 37, the subject matter of any one of Examples 31 to 36 may include, wherein the means for determining the notification for the user comprises: means for identifying a general notification; and means for using the general notification for the notification for the user.

In Example 38, the subject matter of any one of Examples 31 to 37 may include, wherein the general notification is one of: a system status message or an environmental message.

In Example 39, the subject matter of any one of Examples 31 to 38 may include, wherein the means for displaying the notification to the user comprises: means for rendering a notification view, the notification view including the notification to the user; and means for displaying the notification view in place of an existing presentation on the display.

In Example 40, the subject matter of any one of Examples 31 to 39 may include, wherein the existing presentation includes a lock screen of a different user than the user.

In Example 41, the subject matter of any one of Examples 31 to 40 may include, means for receiving user input from the user, the user input to interact with the notification being displayed.

In Example 42, the subject matter of any one of Examples 31 to 41 may include, wherein the user input is one of: an air gesture, a touch gesture, a mouse input, a keyboard input, or a voice command.

In Example 43, the subject matter of any one of Examples 31 to 42 may include, means for detecting a presence of a second user along with the user; receiving a signal from the user, the signal to cause the computing device to display notifications for the user; and means for identifying the user in response to the signal.

In Example 44, the subject matter of any one of Examples 31 to 43 may include, wherein the signal includes an air gesture performed by the user.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for displaying notifications, the system comprising:
a detection module to detect at a computing device, a presence of a user;
an identification module to identify the user;
a notification module to determine a notification for the user when the user is identified; and
a display module to display the notification to the user on a display of the computing device.

2. The system of claim 1, wherein to detect the user presence, the detection module is to:
detect the user presence with a motion detector.

3. The system of claim 2, wherein the motion detector is one of: an infrared detector, a camera, an ultrasonic detector, or an acoustic detector.

4. The system of claim 1, wherein to identify the user, the identification module is to:
obtain an image of the user from a camera proximate to the computing device; and
analyze the image to identify the user.

5. The system of claim 4, wherein the identification module is to:
authenticate the image of the user.

6. The system of claim 1, wherein to determine the notification for the user, the notification module is to:
access an account of the user to obtain data; and
identify the notification from the data.

7. The system of claim 1, wherein to determine the notification for the user, the notification module is to:
identify a general notification; and
use the general notification for the notification for the user.

8. The system of claim 7, wherein the general notification is one of: a system status message or an environmental message.

9. The system of claim 1, wherein to display the notification to the user, the display module is to:
render a notification view, the notification view including the notification to the user; and
display the notification view in place of an existing presentation on the display.

10. The system of claim 9, wherein the existing presentation includes a lock screen of a different user than the user.

11. The system of claim 1, wherein the notification module is to:
receive user input from the user, the user input to interact with the notification being displayed.

12. The system of claim 11, wherein the user input is one of: an air gesture, a touch gesture, a mouse input, a keyboard input, or a voice command.

13. The system of claim 1, wherein the detection module is to detect a presence of a second user along with the user; and
wherein to identify the user, the identification module is to receive a signal from the user, the signal to cause the computing device to display notifications for the user, and identify the user in response to the signal.

14. The system of claim 13, wherein the signal includes an air gesture performed by the user.

15. A method of displaying notifications, the method comprising:
detecting at a computing device, a presence of a user;
identifying the user;
determining a notification for the user when the user is identified; and
displaying on a display of the computing device, the notification to the user.

16. The method of claim 15, wherein detecting the user presence comprises:
detecting the user presence with a motion detector.

17. The method of claim 16, wherein the motion detector is one of: an infrared detector, a camera, an ultrasonic detector, or an acoustic detector.

18. The method of claim 15, wherein identifying the user comprises:
obtaining an image of the user from a camera proximate to the computing device; and
analyzing the image to identify the user.

19. The method of claim 18, further comprising:
authenticating the image of the user.

20. The method of claim 15, wherein determining the notification for the user comprises:
accessing an account of the user to obtain data; and
identifying the notification from the data.

21. At least one machine-readable medium including instructions for displaying notifications, which when executed by a machine, cause the machine to:
detect at a computing device, a presence of a user;
identify the user;
determine a notification for the user when the user is identified; and
display on a display of the computing device, the notification to the user.

22. The at least one machine-readable medium of claim 21, wherein the instructions to detect the user presence comprise instructions to:
detect the user presence with a motion detector.

23. The at least one machine-readable medium of claim 22, wherein the motion detector is one of: an infrared detector, a camera, an ultrasonic detector, or an acoustic detector.

24. The at least one machine-readable medium of claim 21, wherein the instructions to identify the user comprise instructions to:
obtain an image of the user from a camera proximate to the computing device; and
analyze the image to identify the user.

25. The at least one machine-readable medium of claim 21, wherein the instructions to display the notification to the user comprise instructions to:
render a notification view, the notification view including the notification to the user; and
display the notification view in place of an existing presentation on the display.
